(19) United States
(12) Patent Application Publication
(10) Pub. No.: US 2018/0257365 A1
(43) Pub. Date: Sep. 13, 2018

(54) SHEET CONVEYANCE APPARATUS

(71) Applicant: KOMORI CORPORATION, Tokyo (JP)

(72) Inventor: Kenzo KAWAKAMI, Ibaraki (JP)

(21) Appl. No.: 15/758,335

(22) PCT Filed: Sep. 8, 2016
(86) PCT No.: PCT/JP2016/076400

§ 371 Date: Mar. 7, 2018

(30) Foreign Application Priority Data
Sep. 10, 2015 (JP) 2015-178194

(51) Int. Cl. B41F 13/193; B41F 25/00; B41F 7/06; B65H 5/06

(52) U.S. Cl. CPC B41F 13/193; B65H 5/068; B41F 7/06; B41F 25/00

(57) ABSTRACT

A sheet conveyance apparatus (1) is provided in a sheet-fed offset printing press (2) including a printing unit (11). The printing unit (11) includes an impression cylinder (13) configured to hold and convey a sheet (4) and a printing device (14) configured to print the sheet (4) held by the impression cylinder (13). The sheet conveyance apparatus (1) includes a transfer cylinder (28) configured to hand over the sheet (4) to the impression cylinder (13) of the printing unit (11), and a pressing cylinder (29) configured to press the sheet (4) held by the transfer cylinder (28) against an outer surface of the transfer cylinder (28). The pressing cylinder (29) can press the sheet (4) against the transfer cylinder (28), and sufficiently stretch it.

### TECHNICAL FIELD

The present invention relates to a sheet conveyance apparatus of a sheet-fed offset printing press.

### BACKGROUND ART

As disclosed in, for example, patent literatures 1 and 2, a sheet-fed offset printing press includes a sheet conveyance apparatus that feeds sheets from a feeder pile to a printing unit one by one. The feeder pile is formed by stacking a number of sheets, and is arranged at a position adjacent to the printing unit. A feeder board that feeds a sheet is bridged between the feeder pile and the printing unit.

The sheet conveyance apparatus provided in the sheet-fed offset printing press includes a suction device that sucks a sheet on the top of the feeder pile and transfers it to the upstream end portion of the feeder board, and a swing arm shaft pregripper that hands over a sheet between the downstream end portion of the feeder board and the transfer cylinder of the printing unit.

The printing unit of the sheet-fed offset printing press disclosed in patent literature 1 includes a plurality of obverse-side printing units and a plurality of reverse-side printing units, that are arrayed in a sheet conveyance direction. Each of these printing units includes an impression cylinder serving as a sheet conveyance cylinder that holds and conveys a sheet, a blanket cylinder serving as a printing cylinder that contacts the impression cylinder, a plate cylinder that contacts the blanket cylinder, an ink supply device that supplies ink to the plate cylinder, and a dampening device that supplies dampening water to the plate cylinder.

The impression cylinder includes a gripper device that grips and holds the leading edge of the sheet in the conveyance direction, and hands over the sheet to the impression cylinder of another adjacent printing unit. The transfer cylinder to which the sheet is sent by the above-described swing arm shaft pregripper also includes the same gripper device as that of the impression cylinder. The sheet held by the transfer cylinder is handed over to the impression cylinder of the printing unit located on the most upstream side in the sheet conveyance direction.

The sheet passes through a portion between the impression cylinder and the blanket cylinder while being held by the impression cylinder. When the sheet passes through the portion between the impression cylinder and the blanket cylinder, ink is transferred from the blanket cylinder to the sheet, thereby executing printing. The sheet having undergone printing in all the printing units is handed over, to a sheet discharge device, from the impression cylinder located on the most downstream side in the sheet conveyance direction, and stacked on a sheet stacking table by the sheet discharge device.

The sheet-fed offset printing press disclosed in patent literature 2 includes an upper printing device and a lower printing device in order to print both the obverse and reverse surfaces of a paper sheet. The paper sheet is sent from a swing arm shaft pregripper to a portion between the blanket cylinder of the upper printing device and that of the lower printing device via a transfer cylinder. When the paper sheet passes through the portion between the blanket cylinders, both the obverse and reverse surfaces of the paper sheet are printed. This sheet-fed offset printing press includes a setting device that takes up the slack of the paper sheet before the paper sheet conveyed to the printing unit is sandwiched by the pair of blanket cylinders from the transfer cylinder.

This setting device adopts an arrangement of passing the paper sheet through a portion between the transfer cylinder and two rows of brushes arranged near the transfer cylinder and spraying air to the paper sheet. The bristle ends of the brushes are close to the paper sheet. Air is sprayed to the paper sheet through a portion between the two rows of brushes. The two rows of brushes are arrayed in the sheet conveyance direction, and extend from one end to the other end of the transfer cylinder in its axial direction. Air is passed through a slit formed between the two rows of brushes.

This setting device sprays air to the paper sheet in the middle of conveyance by the transfer cylinder, and the paper sheet is pressed against the transfer cylinder by air. If a portion of the paper sheet floats from the transfer cylinder, for example, the paper sheet moves freely, this floating portion is pressed by the brushes.

The sheet-fed offset printing press disclosed in patent literature 1 may supply the sheet to the printing unit via the transfer cylinder in a state in which a portion of the sheet is not in tight contact with the transfer cylinder but floats or moves freely. In this case, even after the sheet is handed over to the impression cylinder of the printing unit, a phenomenon in which a portion of the sheet floats from the impression cylinder or the sheet moves freely is unwantedly reproduced. As a result, the sheet cannot correctly contact the blanket cylinder, causing a printing failure. The printing failure caused when the sheet is not in tight contact with the sheet conveyance cylinder is not a problem only for a printing device of a form in which the above-described printing cylinder contacts the sheet conveyance cylinder but a problem that equally arises in a printing device, such as an inkjet printing device, in which the printing cylinder is spaced apart from the conveyance cylinder.

To solve this problem, for example, the setting device disclosed in patent literature 2 may be used. However, this setting device cannot reliably prevent a printing failure from occurring since the contact state between the brushes and the sheet changes due to the wear or deformation of the brushes. If, for example, the brushes cannot contact the sheet uniformly due to the wear or deformation, it is impossible to sufficiently stretch the sheet, and press the sheet against the transfer cylinder by a strong force of the brushes. This setting device cannot correct wrinkles formed on the sheet or a concave-convex shape in which a portion of the sheet is partially recessed or projects.

### RELATED ART LITERATURE

### Patent Literature

Patent Literature 1: Japanese Patent Laid-Open No. 11-105249

Patent Literature 2: Japanese Utility Model Publication No. 3-12515

### DISCLOSURE OF INVENTION

### Problem to be Solved by the Invention

The present invention has been made in consideration of the problem, and has as its object to provide a sheet conveyance apparatus of a sheet-fed offset printing press capable of pressing a sheet against a transfer cylinder and sufficiently stretching it.

### Means of Solution to the Problem

In order to achieve the above object of the present invention, there is provided a sheet conveyance apparatus provided in a sheet-fed offset printing press including at least one printing unit with a sheet conveyance cylinder configured to hold and convey a sheet and a printing device configured to print the sheet held by the sheet conveyance cylinder, the apparatus comprising a transfer cylinder contacting the sheet conveyance cylinder of the printing unit located on the most upstream side in a sheet conveyance direction among the at least one printing unit and configured to hand over the sheet to the sheet conveyance cylinder, and a pressing cylinder contacting the transfer cylinder and configured to press the sheet held by the transfer cylinder against an outer surface of the transfer cylinder.

### Effect of the Invention

According to the present invention, when a sheet passes through a portion between a transfer cylinder and a pressing cylinder, it is sandwiched between these cylinders. At this time, the sheet is in tight contact with the outer surface of the transfer cylinder by a pressing force from the pressing cylinder, and is handed over to a sheet conveyance cylinder in a state in which the behavior of the sheet is stable without moving freely. Thus, the sheet is also in tight contact with the outer surface of the sheet conveyance cylinder, and is printed by a printing device in a state in which the sheet is along the sheet conveyance cylinder without floating from the sheet conveyance cylinder. As a result, it is possible to always execute printing satisfactorily.

### BRIEF DESCRIPTION OF DRAWINGS

FIG. 1 is a side view showing the schematic arrangement of a sheet conveyance apparatus according to an embodiment of the present invention;

FIG. 2 is an enlarged sectional view showing the main part of the sheet conveyance apparatus shown in FIG. 1;

FIG. 3 is a side view showing a pressing cylinder position adjustment mechanism;

FIG. 4 is a sectional view showing the supporting structure of a pressing cylinder; and

FIG. 5 is a block diagram showing the arrangement of a control system.

### BEST MODE FOR CARRYING OUT THE INVENTION

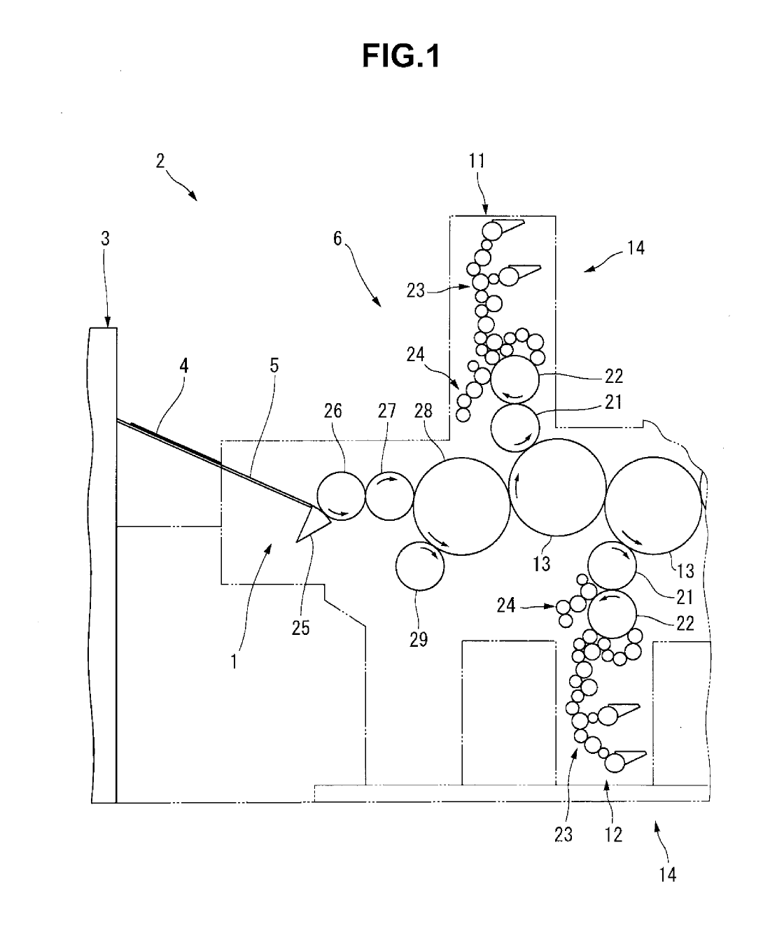

A sheet conveyance apparatus according to an embodiment of the present invention will be described in detail below with reference to FIGS. 1 to 5. A sheet conveyance apparatus 1 of a sheet-fed offset printing press 2 shown in FIG. 1 includes a feeder board 5 to which a sheet 4 is transferred from a sheet supply unit 3 located in an end portion on the left side of FIG. 1, and conveys the sheet 4 to a printing unit 6 located on the right side of FIG. 1 using the feeder board 5. The sheet-fed offset printing press 2 according to this embodiment is equivalent to the sheet-fed offset printing press disclosed in patent literature 1, and includes the sheet supply unit 3, the printing unit 6, and a sheet discharge unit (not shown) connected to the downstream end of the printing unit 6.

The sheet supply unit 3 is provided with a feeder pile (not shown) formed by stacking a number of sheets 4, a suction device (not shown) that transfers the sheet 4 from the feeder pile to the feeder board 5, and the like.

The printing unit 6 includes a plurality of obverse-side printing units 11 and a plurality of reverse-side printing units 12, and adopts an arrangement of executing multicolor offset printing on each of the obverse and reverse surfaces of one sheet 4. FIG. 1 shows only the obverse-side printing unit 11 and the reverse-side printing unit 12 that are located on the most upstream side in a sheet conveyance direction among the plurality of obverse-side printing units 11 and the plurality of reverse-side printing units 12. The sheet conveyance direction is a direction from left to right in FIG. 1.

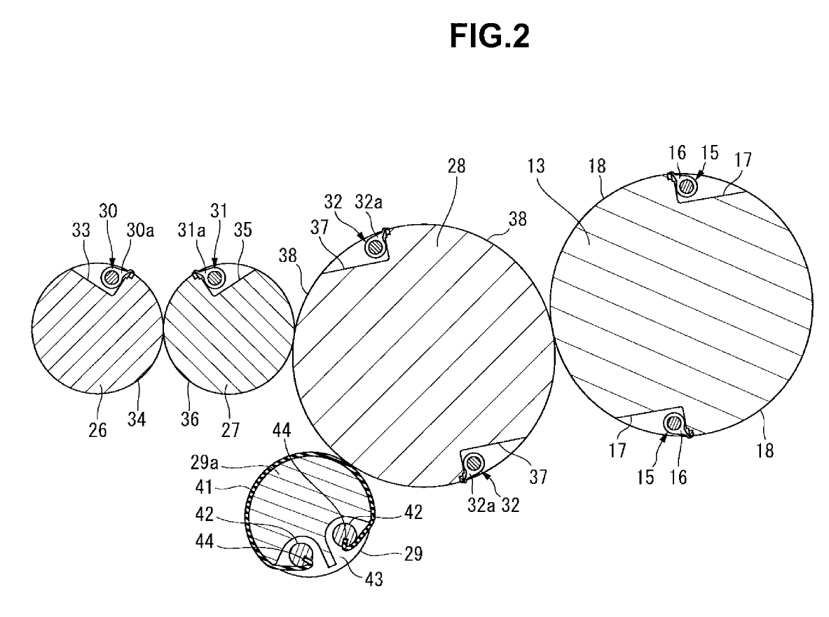

Each of the obverse-side printing units 11 and reverse-side printing units 12 includes an impression cylinder 13 serving as a sheet conveyance cylinder that holds and conveys the sheet 4, and a printing device 14 that prints the sheet 4 held by the impression cylinder 13. As shown in FIG. 2, the impression cylinder 13 includes, at each of two positions in the circumferential direction, a gripper device 15 serving as a sheet holding device that holds the leading edge of the sheet 4. Each gripper device 15 includes a gripper member 16 serving as a sheet holding member. This gripper member 16 is pivotably supported by the impression cylinder 13 to grip the leading edge of the sheet 4, and is accommodated in a notch 17 of the impression cylinder 13. The outer portion of the impression cylinder 13 is formed by two notches 17 and two effective surfaces 18 located between the notches 17. Each effective surface 18 is the outer surface which the sheet 4 overlaps. The sheet 4 held by the gripper device 15 is supported by the effective surface 18 and conveyed. That is, the impression cylinder 13 is a double-size cylinder including two sets each consisting of the notch 17 that accommodates the gripper device 15 for gripping and holding the leading edge of the sheet 4 and the effective surface 18 that supports the sheet 4.

In the sheet-fed offset printing press 2 according to this embodiment, as shown in FIG. 1, the impression cylinders 13 of the obverse-side printing units 11 and the impression cylinders 13 of the reverse-side printing units 12 are alternately arranged in the sheet conveyance direction. The sheet 4 is sent by the sheet conveyance apparatus 1 to the impression cylinder 13 of the obverse-side printing unit 11 located on the most upstream side in the sheet conveyance direction. This sheet 4 is sequentially handed over to all the impression cylinders 13 and sent. When the sheet 4 is conveyed by each impression cylinder 13, the printing device 14 (to be described later) prints the sheet 4. Among the plurality of impression cylinders 13, the impression cylinder 13 located at the downstream end in the sheet conveyance direction sends the sheet 4 to the sheet discharge unit (not shown).

The printing device 14 of each of the obverse-side printing units 11 and reverse-side printing units 12 is a device that contacts the impression cylinder 13 and prints the sheet 4 held by this impression cylinder 13. The printing device 14 includes a blanket cylinder 21 that contacts the impression cylinder 13, a plate cylinder 22 that contacts the blanket cylinder 21, an ink supply device 23 that supplies ink to the plate cylinder 22, and a dampening device 24 that supplies dampening water to the plate cylinder 22.

The sheet conveyance apparatus 1 includes the feeder board 5 that extends from the sheet supply unit 3 toward the printing unit 6, a swing arm shaft pregripper 25 that is located near the downstream end of the feeder board 5, first to third transfer cylinders 26 to 28 that are located between the feeder board 5 and the impression cylinder 13 of the obverse-side printing unit 11, and a pressing cylinder 29 that is located near the third transfer cylinder 28. The swing arm shaft pregripper 25 grips the leading edge of the sheet 4 in the downstream end portion of the feeder board 5, and swings to transfer the sheet 4 to the first transfer cylinder 26.

As shown in FIG. 2, the first to third transfer cylinders 26 to 28 are arrayed in the sheet conveyance direction in a state in which they contact each other. The first to third transfer cylinders 26 to 28 respectively include gripper devices 30 to 32 (sheet holding devices) each of which grips the leading edge of the sheet 4. The first to third transfer cylinders 26 to 28 adopt an arrangement of handing over the sheet 4 using the gripper devices 30 to 32 and sequentially sending it to the downstream side. The gripper devices 30 to 32 are equivalent to the gripper device 15 of the impression cylinder 13. The gripper device 30 of the first transfer cylinder 26 includes a gripper member 30a pivotably supported by the first transfer cylinder 26, and is accommodated in a notch 33 of the first transfer cylinder 26. The first transfer cylinder 26 is a single cylinder including one set of the notch 33 and an effective surface 34 that supports the sheet 4.

The gripper device 31 of the second transfer cylinder 27 includes a gripper member 31a pivotably supported by the second transfer cylinder 27, and is accommodated in a notch 35 of the second transfer cylinder 27. The second transfer cylinder 27 is a single cylinder including one set of the notch 35 and an effective surface 36 that supports the sheet 4. The gripper device 31 of the second transfer cylinder 27 is the same as the above-described gripper device 30 of the first transfer cylinder 26 but the rotation direction of the second transfer cylinder 27 is opposite to that of the first transfer cylinder 26 and thus the second transfer cylinder 27 and the first transfer cylinder 26 are arranged to be plane-symmetrical to each other.

The gripper device 32 of the third transfer cylinder 28 includes a gripper member 32a pivotably supported by the third transfer cylinder 28, and is accommodated in a notch 37 of the third transfer cylinder 28. The third transfer cylinder 28 includes the gripper device 32 at each of two positions in an outer portion. That is, the third transfer cylinder 28 is a double-size cylinder which has a diameter twice that of the first and second transfer cylinders 26 and 27 as single cylinders, and includes two sets each consisting of the notch 37 that accommodates the gripper device 32 and an effective surface 38 that supports the sheet 4.

The third transfer cylinder 28 contacts the impression cylinder 13 of the obverse-side printing unit 11 located on the most upstream side in the sheet conveyance direction (that is, the obverse-side printing unit 11 adjacent to the sheet conveyance apparatus 1) among the plurality of obverse-side printing units 11 and the plurality of reverse-side printing units 12. The third transfer cylinder 28 sends the sheet 4 to the impression cylinder 13 of the obverse-side printing unit 11. In this embodiment, the third transfer cylinder 28 forms a “transfer cylinder” of the present invention.

The pressing cylinder 29 is a cylinder that contacts the third transfer cylinder 28 and presses, against the effective surface 38, the sheet 4 held by the effective surface 38 of the third transfer cylinder 28. The pressing cylinder 29 sandwiches the sheet 4 in cooperation with the third transfer cylinder 28 to stretch the sheet 4 along the third transfer cylinder 28. As shown in FIG. 2, the pressing cylinder 29 according to this embodiment is formed by a blanket cylinder in which a blanket 41 is mounted on the outer surface of a pressing cylinder main body 29a. The blanket 41 is formed into a sheet-like shape by rubber. The blanket 41 is wound around the outer surface of the pressing cylinder main body 29a in a state in which the blanket 41 is stretched with two end portions attached to a pair of winding bars 42.

Each of the pair of winding bars 42 is formed into a rod shape that extends from one end to the other end of the pressing cylinder 29 in its axial direction. In each winding bar 42, a cut groove 44 that extends in the longitudinal direction is formed. The two end portions of the blanket 41 are inserted into the cut grooves 44. The blanket 41 attached to the winding bars 42 is wound around the outer surface of the pressing cylinder main body 29a, and the winding bars 42 are pivotable accommodated in a notch 43 of the pressing cylinder 29. The winding bars 42 are rotated until the blanket 41 is brought into tight contact with the outer surface of the pressing cylinder main body 29a, and fixed to the pressing cylinder main body 29a.

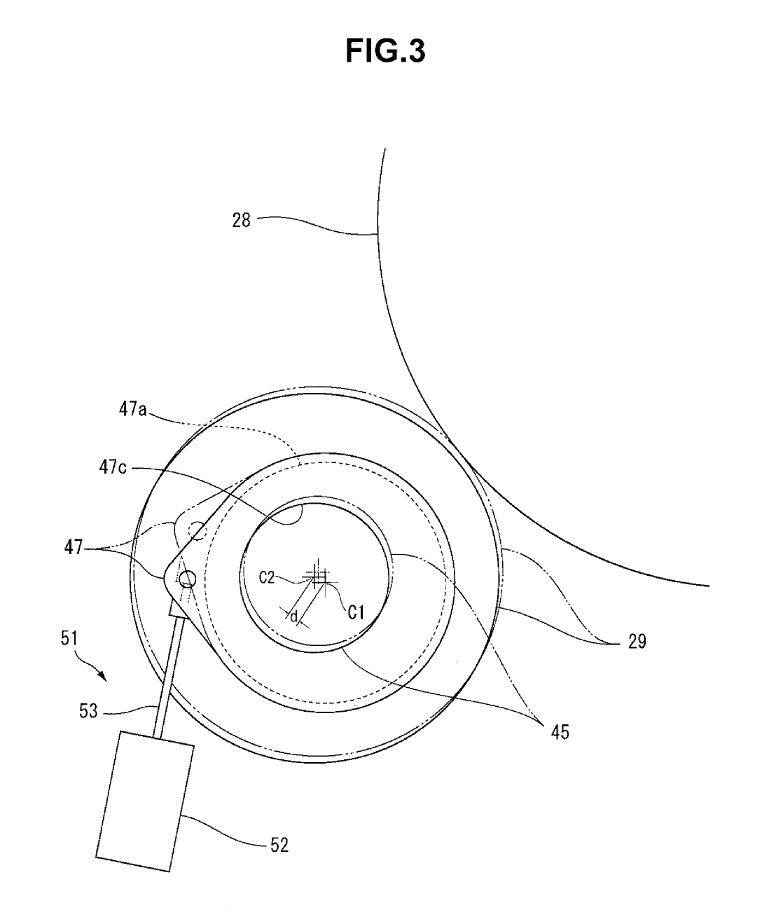

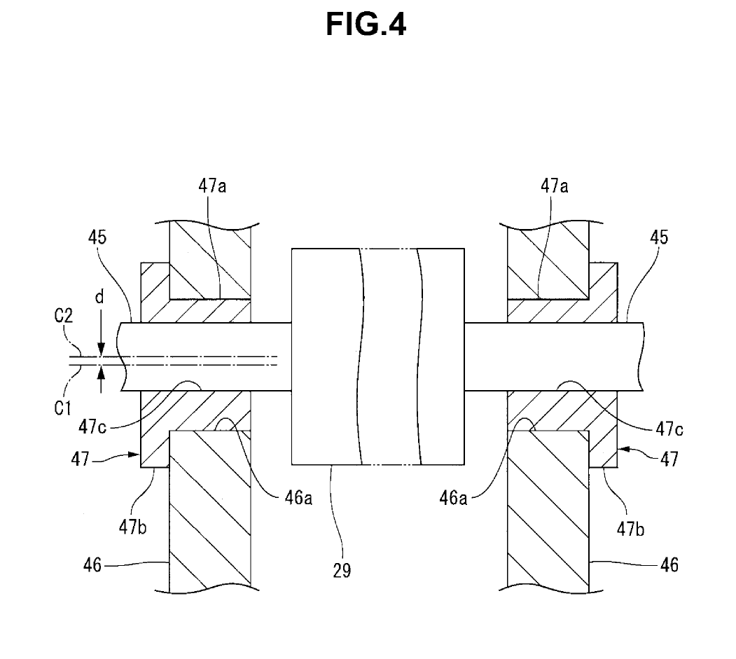

As shown in FIGS. 3 and 4, the pressing cylinder 29 includes two support shafts 45 that respectively project, in the axial direction, from the two end portions in the axial direction. The support shafts 45 are rotatably supported by a pair of frames 46 (see FIG. 4) via eccentric bearings 47. One of the support shafts 45 is provided with a gear (not shown). This gear meshes with the gear (not shown) of the impression cylinder 13, and is connected to a main machine motor serving as a driving device (not shown). The first to third transfer cylinders 26 to 28, the impression cylinder 13, and the like are connected to each other via gears. Thus, the pressing cylinder 29 rotates in synchronism with the first to third transfer cylinders 26 to 28, the impression cylinder 13, and the like by driving the main machine motor. At this time, the pressing cylinder 29 rotates with a phase at which the notch 43 opposes the notch 37 of the third transfer cylinder 28.

In each of the pair of frames 46, as shown in FIG. 4, a circular through hole 46a in which the eccentric bearing 47 is fitted is formed. As shown in FIGS. 3 and 4, the eccentric bearing 47 includes a main body 47a formed into an annular shape and a flange 47b. When the main body 47a of the eccentric bearing 47 is inserted into the through hole 46a of the frame 46 with the flange 47b on the outside, the eccentric bearing 47 is pivotably supported by the frame 46.

The eccentric bearing 47 includes a through hole 47c in which a bearing (not shown) that is not eccentric is mounted. When the two support shafts 45 of the pressing cylinder 29 are inserted from the inside into the through holes 47c of the pair of the eccentric bearings 47, the pressing cylinder 29 is pivotably supported by the pair of eccentric bearings 47.

A center C1 of the outer periphery of (the main body 47a of) the eccentric bearing 47 is eccentric by a distance d with respect to a center C2 of the inner periphery of (the through hole 47c of) the eccentric bearing 47, that is, the center C2 of the support shaft 45 of the pressing cylinder 29. Therefore, as shown in FIG. 3, when the eccentric bearing 47 rotates clockwise, it pivots around the center C1 of the outer periphery. The center C2 of the inner periphery moves in accordance with the pivot, and the center C2 of the support shaft 45 moves from a position indicated by a solid line to a position indicated by a two-dot dashed line.

If the eccentric bearing 47 pivots in this way, the pressing cylinder 29 according to this embodiment can move between a position (to be simply referred to as a “throw-on position” hereinafter) indicated by a two-dot dashed line in FIG. 3 and a position (to be referred to as a “throw-off position” hereinafter) indicated by a solid line in FIG. 3. The throw-on position indicates the position of the pressing cylinder 29, at which the blanket 41 of the pressing cylinder 29 presses the sheet 4 held by the third transfer cylinder 28 against the effective surface 38 of the third transfer cylinder 28. The throw-off position indicates the position of the pressing cylinder 29, at which the pressing cylinder 29 is spaced apart from the third transfer cylinder 28 to generate a predetermined gap between the sheet 4 held by the third transfer cylinder 28 and the blanket 41 of the pressing cylinder 29. That is, the pressing cylinder 29 is supported by the frame 46 to be movable between the throw-on position at which the sheet 4 held by the third transfer cylinder 28 is pressed against the outer surface of the third transfer cylinder 28 and the throw-off position at which the pressing cylinder 29 is spaced apart from the third transfer cylinder 28.

As shown in FIG. 3, a pressing cylinder position adjustment mechanism 51 that adjusts the position of the pressing cylinder 29 with respect to the third transfer cylinder 28 is connected to the eccentric bearing 47. The pressing cylinder position adjustment mechanism 51 has two functions. The first function is a function of switching the position of the pressing cylinder 29 to one of the throw-on position and the throw-off position. The second function is a function of adjusting the throw-on position of the pressing cylinder 29 with respect to the third transfer cylinder 28. In other words, the second function is a function of changing the magnitude of a pressing force when the blanket 41 of the pressing cylinder 29 presses the sheet 4 held by the third transfer cylinder 28.

To implement these functions, the pressing cylinder position adjustment mechanism 51 includes a stepping motor 52, and a driving rod 53 that connects the stepping motor 52 and the eccentric bearing 47 and moves back and forth in accordance with the rotation of the stepping motor 52. The driving rod 53 moves forward in the axial direction when the stepping motor 52 rotates, for example, in the forward direction, and moves backward in the axial direction when the stepping motor 52 rotates, for example, in the reverse direction. When the driving rod 53 moves forward from a position indicated by solid lines in FIG. 3 to move to a position indicated by two-dot dashed lines, the eccentric bearing 47 rotates clockwise in FIG. 3 and the pressing cylinder 29 moves from the throw-off position to the throw-on position.

The pressing cylinder position adjustment mechanism 51 according to this embodiment is provided with the stepping motor 52 and the driving rod 53 in correspondence with each of the left and right eccentric bearings 47 located on the two sides of the pressing cylinder 29 in the axial direction. Note that the left and right eccentric bearings 47 may be connected so as to transfer the power of one stepping motor 52 to the left and right eccentric bearings 47. That is, the pressing cylinder position adjustment mechanism 51 is connected to at least one of the left and right eccentric bearings 47, and is configured to adjust the position of the pressing cylinder 29 with respect to the third transfer cylinder 28 by causing the left and right eccentric bearings 47 to pivot.

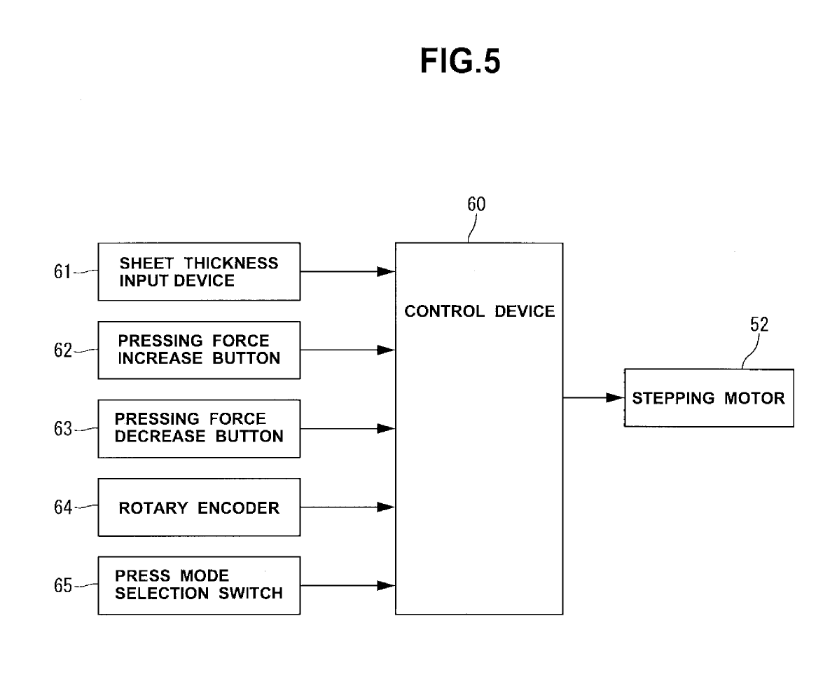

As shown in FIG. 5, the stepping motor 52 is connected to a control device (controller) 60. The control device 60 is connected to a sheet thickness input device 61 to which the thickness of the sheet 4 is input, a pressing force increase button 62 that increases the pressing force when the pressing cylinder 29 is located at the throw-on position, a pressing force decrease button 63 that decreases the pressing force when the pressing cylinder 29 is located at the throw-on position, a rotary encoder 64 serving as a phase detection means for detecting the phase of the sheet-fed offset printing press 2, and a press mode selection switch 65 that selects one of a pressing mode of pressing the sheet 4 by the pressing cylinder 29 and a non-pressing mode of not pressing the sheet 4.

Based on a signal from the rotary encoder 64, the control device 60 rotates the stepping motor 52, for example, in the forward direction so that the pressing cylinder 29 is located at the throw-on position immediately before the first sheet 4 passes through the portion between the pressing cylinder 29 and the third transfer cylinder 28, and rotates the stepping motor 52, for example, in the reverse direction so that the pressing cylinder 29 is located at the throw-off position immediately after the last sheet 4 passes through the portion between the pressing cylinder 29 and the third transfer cylinder 28. Note that the control device 60 controls the stepping motor 52 so as to locate the pressing cylinder 29 at the throw-on position when the notch 43 of the pressing cylinder 29 opposes the notch 37 of the third transfer cylinder 28, and start an operation from the throw-on position to the throw-off position.

Based on the thickness of the sheet 4 input to the sheet thickness input device 61, the control device 60 controls the stepping motor 52 so as to press the sheet 4 by a constant pressing force regardless of the thickness of the sheet 4 by changing the rotation amount of the stepping motor 52 in accordance with the thickness of the sheet 4 used, and adjusting the pivot amount of the eccentric bearing 47. Note that the control device 60 may control the stepping motor 52 so as to set an appropriate pressing force corresponding to the thickness of the sheet 4 based on the thickness of the sheet 4 input to the sheet thickness input device 61.

If the pressing force set based on the thickness of the sheet 4 input to the sheet thickness input device 61 is to be adjusted, the pressing force increase button 62 or the pressing force decrease button 63 is operated to change the position of the pressing cylinder 29 with respect to the third transfer cylinder 28 (the magnitude of the pressing force when the pressing cylinder 29 presses the sheet 4). For example, if the pressing force is to be increased, the pressing force increase button 62 is operated, thereby controlling the stepping motor 52 so as to cause the eccentric bearing 47 to pivot clockwise in FIG. 3. This can move the pressing cylinder 29 closer to the third transfer cylinder 28, thereby increasing the pressing force.

Alternatively, if the pressing force is to be decreased, the pressing force decrease button 63 is operated, thereby controlling the stepping motor 52 so as to cause the eccentric bearing 47 to pivot counterclockwise in FIG. 3. This can move the pressing cylinder 29 away from the third transfer cylinder 28, thereby decreasing the pressing force. The sheet thickness input device 61, the pressing force increase button 62, the pressing force decrease button 63, the control device 60, and the stepping motor 52 form a pressing cylinder position adjustment means for adjusting the position of the pressing cylinder 29. Particularly, the pressing force increase button 62 and the pressing force decrease button 63 form a pressing force adjustment means for adjusting the pressing force.

In the sheet conveyance apparatus 1 with the above arrangement, when printing the sheet 4 that needs to be pressed by the pressing cylinder 29, the press mode selection switch 65 is operated to preset the pressing mode. If printing starts in this state, the sheet 4 is sent from the feeder board 5 to the first transfer cylinder 26 by the swing arm shaft pregripper 25, and further sent from the first transfer cylinder 26 to the third transfer cylinder 28 via the second transfer cylinder 27. The sheet 4 held and conveyed by the third transfer cylinder 28 passes through the portion between the pressing cylinder 29 and the third transfer cylinder 28. At this time, the pressing cylinder 29 is located at the throw-on position. In addition, the pressing cylinder 29 is located at a position where the sheet 4 is pressed by a predetermined pressing force based on the thickness of the sheet 4 input to the sheet thickness input device 61. Thus, when the sheet 4 passes through the portion between the pressing cylinder 29 and the third transfer cylinder 28, the sheet 4 is sandwiched between these cylinders and is in tight contact with the effective surface 38 of the third transfer cylinder 28.

Therefore, according to this embodiment, the sheet 4 is in tight contact with the outer surface of the third transfer cylinder 28 by the pressing force of the pressing cylinder 29, and is handed over to the impression cylinder 13 in a state in which the behavior of the sheet 4 is stable without moving freely. For this reason, the sheet 4 is also in tight contact with the outer surface of the impression cylinder 13, and is printed by the printing device 14 in a state in which the sheet 4 is along the impression cylinder 13 without floating from the impression cylinder 13. As a result, it is possible to always execute printing satisfactorily. Therefore, according to this embodiment, it is possible to provide a sheet conveyance apparatus capable of bringing the sheet 4 into tight contact with the third transfer cylinder 28 and pressing the sheet 4 to sufficiently stretch it.

In this example, the effective surface 38 of the third transfer cylinder 28 is made of a metal or blanket, and is smooth. The surface of the blanket 41 mounted on the outer surface of the pressing cylinder 29 is also smooth. Therefore, the shape of the outer surface of the third transfer cylinder 28 and that of the outer surface of the pressing cylinder 29 are respectively transferred to the obverse and reverse surfaces of the sheet 4 having passed through the portion between the third transfer cylinder 28 and the pressing cylinder 29, thereby obtaining the flat obverse and reverse surfaces. Therefore, especially, both the surfaces of the sheet 4 having a fine concave-convex shape, slack, or wrinkles are flattened when the sheet 4 passes through the portion between the third transfer cylinder 28 and the pressing cylinder 29, and stretched to be corrected, thereby improving the effect of being in tight contact with the outer surface of the third transfer cylinder 28. As a result, the sheet 4 is in tight contact with the outer surface of the impression cylinder 13, making it possible to execute printing more satisfactorily.

The pressing cylinder 29 according to this embodiment is formed by the blanket cylinder with the blanket 41 mounted its outer surface. Therefore, it is possible to prevent the sheet 4 from being sandwiched between the blanket 41 and the third transfer cylinder 28 and compressed by an excessively large force, making it possible to stretch the sheet 4 while keeping the quality of the sheet 4 high.

There are sheets 4 that are unnecessary to be pressed by the pressing cylinder 29, particularly, sheets 4 that must not be pressed such as a sheet 4 that is stretched more than necessary when being pressed by the pressing cylinder 29 and a thin sheet 4 that readily deforms. When printing such sheet 4, the non-pressing mode is preset by operating the press mode selection switch 65. If printing starts in this state, even when the sheet 4 held and conveyed by the third transfer cylinder 28 passes through the portion between the pressing cylinder 29 and the third transfer cylinder 28, the sheet 4 is not sandwiched between these cylinders and is not pressed by the pressing cylinder 29 since the pressing cylinder 29 is located not at the throw-on position but at the throw-off position. Therefore, according to this embodiment, it is possible to provide the sheet conveyance apparatus of the sheet-fed offset printing press that includes the pressing cylinder 29 for stretching the sheet 4 but is not restricted by the type of the usable sheet 4.

The sheet conveyance apparatus 1 according to this embodiment includes the pressing cylinder position adjustment mechanism 51 that changes the position of the pressing cylinder 29 with respect to the third transfer cylinder 28 in a direction in which the pressing force of the pressing cylinder 29 applied to the sheet 4 changes. Thus, the magnitude of the pressing force applied from the pressing cylinder 29 to the sheet 4 is set to an appropriate magnitude in accordance with the thickness of the sheet 4. Therefore, according to this embodiment, it is possible to sufficiently stretch even the thick sheet 4, thereby providing the sheet conveyance apparatus of the sheet-fed offset printing press having a high capability of stretching the sheet 4.

Each of the impression cylinder 13 and the third transfer cylinder 28 according to this embodiment is a double-size cylinder including two sets each consisting of the notch 17 or 37 that accommodates the gripper device 15 or 32 for gripping and holding the leading edge of the sheet 4 and the effective surface 18 or 38 that supports the sheet 4. In this embodiment, the curvature of the sheet 4 when being pressed against the third transfer cylinder 28 by the pressing cylinder 29 is equal to that when being held and conveyed by the impression cylinder 13 except that the warping directions of the sheet 4 are opposite to each other. The state in which the sheet 4 is pressed against the third transfer cylinder 28 and stretched continues without any change even after the sheet 4 is handed over to the impression cylinder 13. Therefore, although the sheet 4 is pressed against the third transfer cylinder 28 and stretched, the state in which the sheet 4 is stretched is maintained even at the time of printing, thereby making it possible to execute printing more accurately. In this embodiment, the impression cylinder 13 and the third transfer cylinder 28 are double-size cylinders. The present invention, however, is not limited to this. A multifold diameter cylinder including two or more sets each consisting of the notch 17 or 37 and the effective surface 18 or 38 is usable. The above-described effect can be obtained when the impression cylinder 13 and the third transfer cylinder 28 are identical multifold diameter cylinders, that is, the diameter of the impression cylinder 13 is equal to that of the third transfer cylinder 28.

The above-described embodiment has explained the example in which the present invention is applied to the sheet-fed offset printing press 2 that prints both the surfaces of the sheet 4. However, the present invention is not limited to this, and is applicable to a sheet-fed offset printing press that prints only one surface of the sheet 4. The above-described embodiment has explained the example in which the sheet-fed offset printing press 2 including the plurality of printing units 11 and 12 is used. However, the number of printing units may be, for example, one.

The above-described embodiment has explained the example in which the offset printing device including the plate cylinder 22 and the blanket cylinder 21 is applied as the printing device 14. However, the present invention is not limited to this, and is applicable to a printing device including a printing cylinder that contacts an impression cylinder like in intaglio printing, screen printing, or relief printing, and a printing device that prints, in a non-contact manner, a sheet spaced apart from a sheet conveyance cylinder like in inkjet printing.

### EXPLANATION OF THE REFERENCE NUMERALS AND SIGNS

1 . . . sheet conveyance apparatus, 2 . . . sheet-fed offset printing press, 4 . . . sheet, 11 . . . obverse-side printing unit, 12 . . . reverse-side printing unit, 13 . . . impression cylinder, 14 . . . printing device, 15, 32 . . . gripper device, 17, 37 . . . notch, 18, 38 . . . effective surface, 28 . . . third transfer cylinder, 29 . . . pressing cylinder, 41 . . . blanket, 47 . . . eccentric bearing, 51 . . . pressing cylinder position adjustment mechanism

1. A sheet conveyance apparatus provided in a sheet-fed offset printing press including at least one printing unit with a sheet conveyance cylinder configured to hold and convey a sheet and a printing device configured to print the sheet held by the sheet conveyance cylinder, the apparatus comprising:
a transfer cylinder contacting the sheet conveyance cylinder of the printing unit located on the most upstream side in a sheet conveyance direction among the at least one printing unit and configured to hand over the sheet to the sheet conveyance cylinder; and
a pressing cylinder contacting the transfer cylinder and configured to press the sheet held by the transfer cylinder against an outer surface of the transfer cylinder.

2. The sheet conveyance apparatus according to claim 1, wherein the pressing cylinder is a blanket cylinder with a blanket mounted on an outer surface.

3. The sheet conveyance apparatus according to claim 1, wherein the pressing cylinder is supported to be movable between a throw-on position at which the sheet held by the transfer cylinder is pressed against the outer surface of the transfer cylinder and a throw-off position at which the pressing cylinder is spaced apart from the transfer cylinder.

4. The sheet conveyance apparatus according to claim 1, further comprising a pressing cylinder position adjustment mechanism configured to adjust a position of the pressing cylinder with respect to the transfer cylinder.

5. The sheet conveyance apparatus according to claim 3, further comprising:
a pair of frames; and
a pair of eccentric bearings pivotably supported by the pair of frames,
wherein the pressing cylinder includes two support shafts respectively projecting from two end portions in an axial direction,
each of the pair of the eccentric bearings includes a hole into which one of the two support shafts is inserted and which rotatably supports the pressing cylinder, and
a center of an inner periphery of the hole is eccentric with respect to a center of an outer periphery of the eccentric bearing including the hole.

6. The sheet conveyance apparatus according to claim 5, further comprising a pressing cylinder position adjustment mechanism connected to at least one of the pair of eccentric bearings and configured to adjust a position of the pressing cylinder with respect to the transfer cylinder by causing the pair of eccentric bearings to pivot.

7. The sheet conveyance apparatus according to claim 6, further comprising a control device connected to the pressing cylinder position adjustment mechanism and configured to control the pressing cylinder position adjustment mechanism,
wherein the control device is configured to adjust pivot amounts of the pair of eccentric bearings in accordance with the thickness of the sheet.
